(19) United States
(12) Patent Application Publication
(10) Pub. No.: US 2014/0076823 A1
(43) Pub. Date: Mar. 20, 2014

(54) PAINT COAGULATION USING FATTY ACIDS

(71) Applicant: HENKEL AG & CO., KGAA, Duesseldorf (DE)

(72) Inventors: Marcus Senner, Kaarst (DE); Steffen Ruebe, Monheim (DE)

(21) Appl. No.: 14/088,631

(22) Filed: Nov. 25, 2013

Related U.S. Application Data
(63) Continuation of application No. PCT/EP2012/056967, filed on Apr. 17, 2012.

(30) Foreign Application Priority Data
May 24, 2011 (DE) 10 2011 076 355.4

(51) Int. Cl. C02F 1/54

(52) U.S. Cl. CPC C02F 1/54
USPC 210/730; 252/181

(57) ABSTRACT

The present invention relates to the use of fatty acids, finely dispersed in water, as detackifying agents in the industrial elimination of dispersed solids, in particular of paint particles dispersed in recirculating water in the context of wet scrubbing of paint overspray in paint booths, from an aqueous carrier medium that represents, in particular, recirculating water of a paint booth with wet scrubbing. The fatty-acid-based detackifying agent can be used in a manner entirely free of corrosive anions, so that energy recovery from the paint coagulate that is removed from the recirculating water can be operated cost-effectively.

The present invention relates to the use of fatty acids finely dispersed in water as detackifying agents in the industrial elimination of dispersed solids, in particular of paint particles dispersed in recirculating water in the context of wet scrubbing of paint overspray in paint booths, from an aqueous carrier medium that in particular represents recirculating water of a paint booth with wet scrubbing. The fatty-acid-based detackifying agent can be used in a manner entirely free of corrosively acting actions, and has the result that energy recovery from the paint coagulate removed from the recirculating water can be operated cost-effectively.

In painting facilities, in particular in automobile construction, one or more solvent- or water-based paint layers are usually sprayed onto the components. In the context of such an application of paints, waxes, or similar non-water-soluble organic coating agents onto metallic surfaces or plastic surfaces, the paints resp. coating agents do not end up being applied exclusively onto the parts to be coated. That portion of the paint which does not, as desired, become deposited onto the components, and must be removed from the recirculating air, is referred to as “paint overspray.” In order to be separated out from the recirculating air, the paint overspray is introduced into a liquid carrier medium, usually water, and after detackifying and coagulation of the particulate paint constituents is removed from the carrier medium and further utilized. Depending on the system configuration and process management, the detackified and coagulated paint particles float or sediment in a settling tank (system tank) into which the carrier medium loaded with the paint overspray is conveyed. Discharge of the coagulate from the carrier medium occurs in the system tank continuously and with suitable discharge apparatuses and/or separators. The carrier medium, depleted of coagulate, is likewise fed continuously back into the paint booth, for example as recirculating water, so that a closed-cycle system is implemented.

Wet scrubbing of paint overspray in the paint booth is often accomplished by turbulent mixing of recirculating water (carrier medium) and the aerosol of the overspray by means of a venturi opening in the recirculating air conduit of the paint booth. An air-water mixture containing the coarsely and/or finely distributed paint particles is thereby produced, which mixture has a lowered density compared with the recirculating water in the system tank. Injection of the air-water mixture at a predefined flow rate into the system tank for coagulation and physical separation thus has the consequence that this air-water mixture moves upward at the inlet point of the system tank because of the lower density, so that flotation systems are often needed for separating out the paint coagulate.

Alternatively, the paint overspray is removed from the paint booth by means of a water curtain, and is conveyed into a settling tank for sedimentation. Regardless of the separation method, detackification of the paint particles to yield a discharge-capable coagulate is a necessary condition for effective elimination of the paint overspray. The standard detackifying agents used are polyvalent metal cations, for example, ions of magnesium, calcium, iron, zinc, and/or aluminum. These highly charged positive ions effect the process of detackifying and flocculating the paint particles. Because the metal cations are continuously removed from the recirculating water along with the paint coagulate, the detackifying agent must continuously be re-metered into the recirculating water. Associated with this is the fact that the anions introduced along with the polyvalent metal salt accumulate in the recirculating water. Highly concentrated metal salt solutions are therefore preferred in terms of applications engineering; in order to suppress corrosive processes on working parts of the recirculating bath, these contain neither halide anions (metal corrosion) or sulfate ions (concrete corrosion). In addition, for reasons of environmental compatibility and elevated costs, the use of phosphate- and nitrate-containing salts is to be avoided in accordance with regulatory guidelines for the discharge of waste water.

EP 1865033 proposes a concentrated aqueous solution of aluminum carboxylate salts as a detackifying agent in order to avoid the accumulation of corrosive anions in the context of paint coagulation; the anion of a hydroxymonocarboxylic acid is to be present as a carboxylate anion, and the solution contains at least two equivalents of hydroxymonocarboxylic acid per mol aluminum. According to the teaching of EP 1865033, an aqueous solution of aluminum lactate is particularly preferable for paint coagulation.

Polymers that are introduced in specific concentrations into the carrier medium can likewise have a detackifying effect. EP 1937601, for example, discloses the use of concentrated aqueous solutions of protonated polyalkyleneimines as detackifying agents for paint coagulation in the wet scrubbing system of a painting facility. In order to minimize undesired corrosion phenomena in the painting facility, firstly halide ions from the polymer concentrate resp. detackifying agent are replaced by hydroxide ions in a complex membrane method, after which, by reacidification of the solution, anions such as sulfate ions, phosphate ions, borate ions, nitrate ions, and anions of organic acids are introduced into the detackifying agent. Detackifying of the paint overspray is further assisted by the additional introduction of polyvalent metal, so that the addition of metal cations, selected from ions of magnesium, calcium, and/or aluminum ions, to the polymer concentrate formula is particularly preferred according to the teaching of EP 1937601.

The use of melamine-formaldehyde condensation products as detackifying agents is also widespread, since such polymers reliably detackify both water-based and solvent-based paint overspray. Detackifying agents of this kind are taught by U.S. Pat. No. 4,888,386 and U.S. Pat. No. 5,068,279, particular attention being paid to possibilities for reducing the free formaldehyde content, the partial release of which is nevertheless inherent in the use of this class of polymer, so that there is no prospect of sustained industrial commercialization of this type of detackifying agent.

Alternatively, and to limit the ion load in the recirculating water, dispersions of silicates, preferably sheet silicates, are used as a detackifying agent to separate paint overspray out of an aqueous carrier medium (recirculating water of the wet scrubbing system). Slurries of these silicates are usually metered into the recirculating water for detackification. U.S. Pat. No. 4,564,464 teaches, for example, the introduction of a pumpable slurry of hectorite into the recirculating water of a painting facility with wet scrubbing in order to detackify solvent-based and water-based paint overspray.

In the existing art, the solids, separated by flotation or sedimentation from the carrier medium resp. recirculating water and removed from the system tank, are often delivered to an energy recovery system using thermal incineration. Energy recovery of this kind makes sense, however, only if the paint coagulate has sufficient calorific value, so that the solids removed from the system tank should have a high organic proportion. The use of detackifying agents based on inorganic compounds, for example of concentrated metal salt solutions or silicate suspensions, is therefore additionally disadvantageous for the operation of painting facilities with wet scrubbing and energy recovery from the paint coagulate, since the calorific value of the discharged solid containing the detackifying agent is greatly diminished, and the proportion of combustion incineration residues to be disposed of is comparatively high.

The object of the present invention is consequently to make available an alternative detackifying agent in a method for eliminating solids from a carrier medium, in particular for wet scrubbing of paint overspray out of the recirculating water of a paint booth, in which method the utilization of the detackifying agent on the one hand does not cause any increase in the concentration of corrosive anions, and on the other hand ensures a high calorific value for the solid material (paint coagulate) removed from the carrier medium.

It has been found, surprisingly, that organic fatty acids and salts thereof, which are present in finely dispersed form in aqueous solution, are as such outstandingly suitable as detackifying agents for the elimination of dispersed solids from aqueous carrier media. The subject of the invention is therefore the use of an aqueous dispersion of at least one fatty acid and/or one salt of a fatty acid as a detackifying agent in methods for eliminating resp. removing particulate solids from an aqueous carrier medium, the aqueous dispersion of the at least one fatty acid and/or of the at least one salt of a fatty acid having a D90 value of less than 50 μm and possessing a pH not below 5, preferably in the range from 6 to 9.

The aqueous detackifying agent on the basis of fatty acids that is used according to the invention contains no damaging anions and/or ones that act corrosively, and is therefore particularly well suited for use in technical systems such as recirculating water in the context of paint coagulation. In addition, the detackifying agent used according to the present invention is notable for the fact that as compared with detackifying agents based on inorganic salts or silicates which are often used in the existing art, it contributes significantly to the calorific value of the paint coagulate and thus makes exploitation of the energy of the paint coagulate by thermal recovery significantly more efficient.

An “aqueous dispersion” is understood according to the present invention as an aqueous composition that also contains, besides a proportion of the fatty acids dissolved in water, an emulsified and/or dispersed proportion of the fatty acids, so that dispersions according to the present invention always represent hetereogeneous substance mixtures. No distinction is made according to the present invention between emulsion and dispersion, since according to the present invention the fatty acids and/or salts thereof can be present in heterogeneously distributed fashion in the aqueous phase regardless of their aggregate state. The aqueous dispersions offer the technical advantage that when diluted in the aqueous carrier medium, i.e. when used according to the present invention in the carrier medium, rapid accumulation of the fatty acids and/or salts thereof at the heterogeneous phase boundaries can occur, so that solids dispersed in the carrier medium can be effectively detackified and mechanically discharged.

A “detackifying agent” is understood according to the present invention as an agent suitable for detackifying particulate solids, preferably organic paint particles, in a homogeneous liquid, the detackification consisting in the fact that the solid particles form in the carrier medium, in response to the detackifying agent, a mechanically dischargeable agglomerate. A detackified agglomerate can be removed mechanically from the carrier medium by flotation or sedimentation using methods known in the existing art. Agglomerates are mechanically dischargeable in particular when the agglomerate remains coarsely dispersed in the carrier medium and does not form a continuous phase, for example in the form of a film floating on the carrier medium or adhering to the walls of the system tank.

An “aqueous carrier medium” is understood according to the present invention as a homogeneous liquid whose liquid component is made up of at least 50 wt % water, and in which the particulate solids to be eliminated are present in heterogeneously distributed fashion. The particulate solids to be eliminated can be, for example, paint particles that, in a paint booth with wet scrubbing of paint overspray, have traveled into the aqueous carrier medium, from which they are eliminated resp. removed by means of flotation and/or sedimentation using the aqueous dispersion.

The D90 value of the aqueous dispersion indicates that 90 vol % of the dispersed constituents of the aqueous dispersion have a size below the indicated value. The D90 value is ascertained according to the present invention from volume-weighted cumulative particle size distributions, where the particle size distribution curve can be determined directly in the aqueous dispersion with the aid of ultrasonic spectroscopy.

Fatty acids and/or salts thereof that can be used in dispersed form when utilized according to the present invention as a detackifying agent are all monocarboxylic acids having a branched or unbranched, saturated or unsaturated aliphatic residue, as well as salts thereof.

In a use according to the present invention, the fatty acids are preferably selected from saturated and unsaturated fatty acids having 10 to 25 carbon atoms, particularly preferably 14 to 22 carbon atoms, particularly preferably 16 to 20 carbon atoms, as well as salts thereof.

Special representatives of preferred fatty acids as well as salts thereof are capric acid, undecanoic acid, lauric acid, tridecanoic acid, myristic add, pentadecanoic acid, palmitic acid, heptadecanoic acid, stearic acid, octadecan-12-olic acid, nonadecanoic acid, arachidic acid, heneicosanoic acid, behenic acid, tricosanoic acid, lignoceric acid, pentacosanoic acid, undecenoic acid, lauroleic acid, myristoleic acid, palimitoleic acid, petroselaidic acid, linolaidic acid, elaidic acid, linoleic acid, petroselinic acid, β-eleostearic acid, linolenic acid, α-eleostearic acid, oleic acid, ricinoleic acid, arachidonic acid, gadoleic acid, erucic acid, brassidic acid, clupanodonic acid.

The saturated fatty acids as well as salts thereof are particularly preferred because of their lower biodegradability, in order to avoid the establishment of microorganisms in the carrier medium and during operation, as well as down times in a system for eliminating particulate solids. Particularly preferred in this connection are myristic acid, pentadecanoic acid, palmitic acid, heptadecanoic acid, stearic acid, octadecan-12-olic acid, nonadecanoic acid, arachidic acid, heneicosanoic acid and/or behenic acid, in particular stearic acid.

For the use according to the present invention of the aqueous dispersion of the at least one fatty acid and/or salts thereof, the salts of the at least one fatty acid are preferably selected from lithium, sodium, potassium, magnesium, calcium, and/or aluminum salts, particularly preferably from sodium, potassium, magnesium, and/or calcium salts, especially preferably from sodium and/or potassium salts. In the use according to the present invention, the presence of polyvalent cations can promote the agglomeration of inorganic solids, for example pigments or fillers, which are typical paint constituents. The presence of polyvalent cations is not necessary, however, for efficient detackification of the solids dispersed in the carrier medium, so that their proportion in the aqueous dispersion is preferably kept low for economic reasons. Conversely, salts of the fatty acids based on monovalent cations can be incorporated in larger quantities into the aqueous dispersion because of their higher water solubility. The formulation of dispersions that are highly concentrated in terms of the fatty acid component, and thus the provision of a maximally cost-effective concentrate, represents according to the present invention an important additional object, the achievement of which is contributed to by the use of the preferred monovalent salts of the fatty acids.

When the aqueous dispersion is used according to the present invention, the total proportion of fatty acids and/or salts of fatty acids, calculated as free fatty acids, in the aqueous dispersion is preferably at least 2 wt %, particularly preferably at least 8 wt %, especially preferably at least 15 wt %, and is preferably no more than 50 wt %. Above a proportion of 50 wt %, a finely particulate dispersion of the fatty acids and salts thereof is almost impossible to achieve, and at the same time extremely viscous compositions are generated, thus also making it difficult to produce a meterable concentrate.

It has furthermore been found, surprising, that finely dispersed mixtures of fatty acids and/or salts thereof are easily obtained when specific dispersion adjuvants based on protonated or quaternized organic amines are added to the aqueous dispersion.

It is therefore preferred according to the present invention to use those aqueous dispersions which additionally comprise at least one dispersion adjuvant selected from protonated or quaternized organic amine compounds that comprise at least one hydroxyl group or at least one additional amino group, or fatty acid esters thereof or fatty acid amides thereof. In particular, the fatty acid esters and fatty acid amides of quaternized organic amine compounds having at least one hydroxyl group resp. having at least one further amino group yield aqueous dispersions in which the fatty acid component and/or the component of salts of the fatty acids is present in finely dispersed and outstandingly stabilized fashion.

Especially preferred for the use according to the present invention of the aqueous dispersions are those dispersion adjuvants based on protonated and/or quaternized organic amine compounds that correspond to the following general empirical formula:

[N[(—CR¹R²)ₚ-X]ₙY_{4-n]}¹⁺Z^{m-}_{1/m},

where
the residues X are selected, mutually independently in each case, from an amine group or hydroxyl group, preferably a hydroxyl group;
the residues R¹ and R² are selected, mutually independently in each case, from hydrogen, methyl, ethyl, or propyl, preferably from hydrogen or methyl;
p is a natural integer from 1 to 6, preferably from 2 to 4;
n is a natural integer from 1 to 4, preferably from 3 to 4;
the residues Y are selected, mutually independently in each case, from hydrogen or saturated aliphatic residues having no more than 6, preferably no more than 4, carbon atoms;
Z is an anion having a valency m, which preferably is selected from hydroxide ions or anionic monoalkyl sulfates having no more than 4 carbon atoms in the alkyl residue.

Particularly preferred in the context of the use according to the present invention are those dispersion adjuvants based on protonated and/or quaternized organic amine compounds which are selected from protonated and/or quaternized alkanolamines having a molar mass of less than 500 g/mol, in turn preferably selected from protonated or quaternized N,N-dimethylethanolamine, N-methyldiethanolamine, or triethanolamine, particularly preferably selected from quaternized triethanolamine, where the quaternization is preferably accomplished via a methylation, ethylation, or propylation.

Protonated or quaternized polyalkyleneimines act in similar fashion as dispersion adjuvants, and are preferably selected from protonated or quaternized polyethyleneimines, polypropyleneimines, poly(2-hydroxypropyleneimines), amidoamines, or from copolymers that comprise protonated or alkylated 1,2-ethanediamine moieties, so that such compounds can likewise be contained in the aqueous dispersion as dispersion adjuvants, the protonated or quaternized polyalkyleneimines preferably having a weight-average molecular weight of at least 500 u, preferably at least 1000 u.

A further result of adding the at least one dispersion adjuvant to the aqueous dispersion, beyond more-finely particulate dispersion of the fatty acid component and/or the component of the salts of the fatty acids, is that in a context of large proportions of fatty acids and salts thereof, the aqueous dispersion has a lower structural viscosity as compared with aqueous dispersions that contain no dispersion adjuvant. This is of technical significance for the provision of meterable concentrates.

When the aqueous dispersion is used according to the present invention, the weight proportion of the dispersion adjuvant in the aqueous dispersion is preferably in the range from 0.1 to 20%, particularly preferably in the range from 2 to 10%, based on the total proportion of fatty acids and/or salts of fatty acids, calculated as the total proportion of free fatty acids.

It has furthermore been found, surprisingly, that the proportion of fatty acids and/or salts thereof in the aqueous dispersion can additionally be increased by the fact that specific solubilizers based on polyalkylene glycols are added to the aqueous dispersion.

In a further preferred use of the aqueous dispersion, the latter therefore additionally contains at least one solubilizer selected from polyalkylene glycols, preferably polyethylene glycols, polypropylene glycols, or polyethylene/propylene glycols, or ethers thereof, that each contain 3 to 10 oxygen atoms and no more than 24 carbon atoms, the HLB value of the polyalkylene glycol ethers being greater than 12, preferably greater than 16.

The HLB value (hydrophilic-lipophilic balance) serves for quantitative classification of amphiphilic molecules in accordance with the internal structure of the amphiphile, a subdivision of the amphiphile into a lipophilic and a hydrophilic group being performed.

The HLB value according to the present invention is calculated according to the following formula and can assume values from zero to 20 on an arbitrary scale:

HLB=20*(1−-Mₗ/M)

where
Mₗ=molar mass of the lipophilic group of the amphiphile
M=molar mass of the amphiphile.

When the aqueous dispersion is used according to the present invention, the proportion of solubilizer in the aqueous dispersion is in the range from 1 to 20 wt %, preferably in the range from 2 to 10 wt %. Below a 1 wt % proportion of solubilizer, based on the total proportion of fatty acids and/or salts of fatty acids, there is almost no influence on the polarity of the aqueous phase and thus on the solution behavior for fatty acids and salts thereof. It has likewise been found that with such a low proportion, dispersion of the fatty acids and salts thereof in the presence of a dispersion adjuvant also cannot be additionally promoted. Above a 20 wt % weight proportion of solubilizer, the viscosity can in turn rise sharply, and can make it difficult to disperse the fatty acids and salts thereof, and thus also to produce a meterable concentrate.

Because the detackification of solids dispersed in aqueous carrier media is already sufficiently accomplished by means of the fatty acids and salts thereof that are metered into the carrier medium in the form of the aqueous dispersion, no polyvalent cations are necessary for detackification, so that the weight proportion of polyvalent cations in the aqueous dispersion in the context of the use according to the present invention can, for reasons of cost-effectiveness, preferably be below 5%, particularly preferably below 1%, based on the total proportion of fatty acids and/or salts of fatty acids, calculated as the total proportion of free fatty acids.

In order to minimize corrosion damage in system facilities for eliminating dispersed solids from an aqueous carrier medium, a preferred use according to the present invention comprises the fact that the aqueous dispersion contains less than 1 wt %, preferably less than 0.1 wt % inorganic anions that are not hydroxide ions.

A use according to the present invention of the aqueous dispersion as a detackifying agent in methods for eliminating resp. removing particulate solids from the carrier medium is, in general, always implemented in those methods which provide for metering the aqueous dispersion into the carrier medium. For effective detackification, it is preferred that the aqueous dispersion be metered into the aqueous carrier medium containing particulate solids in a quantity such that a total weight proportion of fatty acids and/or salts of fatty acids, calculated as free fatty acids, from 0.05 to 10%, particularly preferably from 0.1 to 5%, based on the solid proportion, is present in the aqueous carrier medium. The solid proportion is the proportion of all dispersed solids in the aqueous carrier medium. The solid proportion can be determined gravimetrically as a membrane residue after ultrafiltration of a sample volume of the carrier medium in dead-end mode, ultrafiltration being performed with membranes having a molecular exclusion limit of 10 kDa.

In methods according to the present invention, the separation of solids from the aqueous carrier medium is not based on metering in polyvalent cations or alternative detackifying agents known in the existing art, so that the presence thereof can very largely be dispensed with.

In a preferred method for separating solids out of an aqueous carrier medium, in total less than 0.1 wt %, particularly preferably in total less than 0.05 wt % of inorganic compounds, selected from water-soluble compounds that release polyvalent cations, and silicates, and in total less than 1 wt % of organic polymeric compounds having a weight-average molar mass of more than 10,000 u, based in each case on the solid proportion in the aqueous carrier medium, is therefore metered in.

Flotation methods are particularly preferred for elimination of the particulate solids in the context of use according to the present invention of the aqueous dispersion, the fatty acids and/or the corresponding salts of the fatty acids in the aqueous dispersion preferably being selected from fatty acids that, as pure substances, have a density of no more than 0.85 g/cm³ measured at 80° C.

Furthermore preferred is a use according to the present invention such that the aqueous dispersion for paint coagulation is metered into recirculating water from paint booths with wet scrubbing, where metering of 0.05 to 10 wt % of the fatty acids and/or salts of the fatty acids, calculated as free fatty acids, into the aqueous dispersion occurs, based on the weight proportion of the paint overspray.

Also encompassed by the present invention is an aqueous dispersion for use as a detackifying agent in painting facilities with wet scrubbing of paint overspray. An aqueous dispersion of this kind has a pH not below 5, preferably in the range from 6 to 9, and contains, besides water,
a) in total 2 to 50 wt %, preferably 10 to 50 wt %, fatty acids and/or salts of fatty acids, calculated as free fatty acids;
b) 1 to 20 wt %, preferably 5 to 15 wt %, of at least one solubilizer as described above;
c) 0 to 5 wt %, preferably at least 0.1 wt %, of at least one dispersion adjuvant as described above;
d) less than 1 wt % inorganic anions that are not hydroxide ions, the aqueous dispersion having a D90 value of less than 50 μm.

Fatty acids and/or salts thereof that can be employed in the aqueous dispersion according to the present invention for use as a detackifying agent in painting facilities with wet scrubbing of paint overspray are all monocarboxylic acids having a branched or unbranched, saturated or unsaturated aliphatic residue, as well as salts thereof. Preferred fatty acids and/or salts thereof may be gathered from the description.

1. A method of eliminating particulate solids from an aqueous carrier medium comprising detackifying said solids by contacting with an aqueous dispersion of at least one fatty acid and/or salt of a fatty acid, the aqueous dispersion of the at least one fatty acid and/or at least one salt of a fatty acid having a D90 value of less than 50 μm and possessing a pH not below 5.

2. The method according to claim 1, wherein said at least one fatty acid and/or salt of a fatty acid are selected from the group consisting of saturated and unsaturated fatty acids having 10 to 25 carbon atoms and salts thereof.

3. The method according to claim 1, wherein the salt of the fatty acid is selected from salts of lithium, sodium, potassium, magnesium, calcium, and aluminum.

4. The method according to claim 1, wherein the aqueous dispersion additionally comprises at least one dispersion adjuvant selected from protonated or quaternized organic amine compounds that comprise at least one hydroxyl group or at least one further amino group, or fatty acid esters thereof or fatty acid amides thereof.

5. the method according to claim 4, wherein the protonated or quaternized organic amine compounds correspond to general empirical formula I:
[N[(—CR¹R²)ₚ-X]ₙY_{4-n]}¹⁺Z^{m-}_{1/m} I
where
X is selected, mutually independently in each case, from an amine group or hydroxyl group;
R¹ and R² are selected, mutually independently in each case, from hydrogen, methyl, ethyl, or propyl;
p is a natural integer from 1 to 6;
n is a natural integer from 1 to 4;
Y is selected, mutually independently in each case, from hydrogen or saturated aliphatic residues having no more than 6 carbon atoms;
Z is an anion having a valency “m”, and said anion is selected from hydroxide ions or anionic monoalkyl sulfates having no more than 4 carbon atoms in the alkyl residue.

6. The method according to claim 5, wherein the protonated or quaternized organic amine compounds are selected from protonated or quaternized alkanolamines having a molar mass of less than 500 g/mol

7. The method according to claim 6, wherein the protonated or quaternized organic amine compounds are selected from protonated or quaternized N,N-dimethylethanolamine, N-methyldiethanolamine, or triethanolamine.

8. The method according to claim 1, wherein the aqueous dispersion additionally comprises at least one dispersion adjuvant selected from protonated or quaternized polyalkyleneimines.

9. The method according to claim 8, wherein protonated or quaternized polyalkyleneimines are selected from the group consisting of protonated or quaternized polyethyleneimines, polypropyleneimines, poly(2-hydroxypropyleneimines), amidoamines, copolymers comprising protonated or alkylated 1,2-ethanediamine moieties.

10. The method according to claim 1, wherein the aqueous dispersion additionally comprises at least one solubilizer selected from polyalkylene glycols or ethers thereof, that each contain 3 to 10 oxygen atoms and no more than 24 carbon atoms, the HLB value of the polyalkylene glycol ethers being greater than 12.

11. The method according to claim 1, wherein the at least one fatty acid and/or one salt of a fatty acid is present in the aqueous dispersion in an amount of at least 2 wt % and no more than 50 wt %, calculated as free fatty acids.

12. The method according to claim 11, wherein the dispersion adjuvants are present in the aqueous dispersion in an amount ranging from 0.1 to 20 wt %, based on the amount of fatty acids and/or salts of fatty acids.

13. The method according to claim 1, wherein the solubilizers are present in the aqueous dispersion in an amount ranging from 1 to 20 wt %.

14. The method according to claim 11, wherein the weight proportion of polyvalent cations in the aqueous dispersion is below 5%, based on the amount of fatty acids and/or salts of fatty acids.

15. The method according to claim 1, wherein the aqueous dispersion contains less than 1 wt % of inorganic anions that are not hydroxide ions.

16. An aqueous dispersion for use as a detackifying agent in painting facilities with wet scrubbing of paint overspray, having a pH not below 5, comprising, in addition to water,
a) in total 2 to 50 wt % fatty acids and/or salts of fatty acids, calculated as free fatty acids;
b) 1 to 20 wt % of at least one solubilizer selected from polyalkylene glycols or ethers thereof;
c) 0 to 5 wt % of at least one dispersion adjuvant selected from protonated or quaternized organic amine compounds that comprise at least one hydroxyl group or at least one further amino group, or fatty acid esters thereof or fatty acid amides thereof;
d) less than 1 wt % inorganic anions that are not hydroxide ions, the aqueous dispersion having a D90 value of less than 50 μm.

17. The aqueous dispersion according to claim 16, wherein the aqueous dispersion is free of halide anions, sulfate ions, phosphate-containing salts and nitrate-containing salts.
